(19) United States
(12) Patent Application Publication
(10) Pub. No.: US 2007/0196697 A1
(43) Pub. Date: Aug. 23, 2007

(54) Perpendicular magnetic recording medium

(75) Inventors: Taek-dong Lee, Seoul (KR); Young-wook Tahk, Suwon-si (KR); Sung-chul Lee, Daejeon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/581,326

(22) Filed: Oct. 17, 2006

(30) Foreign Application Priority Data
Feb. 22, 2006 (KR) 10-2006-0017244

(51) Int. Cl. G11B 5/66

(52) U.S. Cl. 428/828.1

(57) ABSTRACT

A perpendicular magnetic recording medium is provided, the perpendicular magnetic recording medium including: a substrate; a first soft magnetic underlayer formed on the substrate; a perpendicular anisotropic middle layer that is formed on the first soft magnetic underlayer and has perpendicular magnetic anisotropy; a second soft magnetic underlayer formed on the perpendicular anisotropic middle layer; and a perpendicular magnetic recording layer formed on the second soft magnetic underlayer.

### CROSS-REFERENCE TO RELATED PATENT APPLICATION

This application claims priority from Korean Patent Application No. 10-2006-0017244, filed on Feb. 22, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a perpendicular magnetic recording medium, and more particularly, to a perpendicular magnetic recording medium with an improved structure of layers between a substrate and a perpendicular magnetic recording layer in order to reduce noise.

2. Description of the Related Art

Recently, the recording density area of recording media such as magnetic disks has been significantly increased. Specifically, in order to increase the recording density area of the magnetic disk, a perpendicular magnetic recording method has been suggested. In this case, a magnetic recording layer is magnetized in a perpendicular direction to increase the recording density. The magnetic recording layer for perpendicular magnetization is formed of a magnetic material having relatively high magnetic anisotropy and high coercivity.

In order to facilitate recording data to the perpendicular magnetic recording layer by effectively magnetizing the perpendicular magnetic recording layer, a soft magnetic underlayer is disposed between the perpendicular magnetic recording layer and a substrate supporting the perpendicular magnetic recording layer. A magnetic head is disposed above the perpendicular magnetic recording layer to form a magnetic flux to magnetize the perpendicular magnetic recording layer.

During recording, the magnetic flux emitted from a recording pole of the magnetic head magnetizes the perpendicular magnetic recording layer in units of bit areas, flows along the soft magnetic underlayer disposed under the perpendicular magnetic recording layer, and returns to a return pole of the magnetic head. Because the soft magnetic underlayer is disposed under the perpendicular magnetic recording layer, a magnetic circuit is easily formed in the magnetic recording medium and the magnetic flux emitted from the recording pole is not disturbed and effectively delivered to the perpendicular magnetic recording layer. Thus, the perpendicular recording layer is effectively magnetized.

However, to form a magnetic circuit in the soft magnetic underlayer easily, the soft magnetic underlayer should not become saturated. For this, the soft magnetic underlayer should have a specified thickness and sufficient saturation magnetization (Ms). However, when a thick soft magnetic underlayer is formed, a magnetic vortex occurs due to the magnetic flux emitted from the recording pole during magnetic recording, and the magnetic vortex causes delay of magnetization time and noise.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a perpendicular magnetic recording medium having a soft magnetic underlayer structure which suppresses a magnetic vortex to effectively reduce noise.

According to an aspect of the present invention, there is provided a perpendicular magnetic recording medium including: a substrate; a first soft magnetic underlayer formed on the substrate; a perpendicular anisotropic middle layer that is formed on the first soft magnetic underlayer and has perpendicular magnetic anisotropy; a second soft magnetic underlayer formed on the perpendicular anisotropic middle layer; and a perpendicular magnetic recording layer formed on the second soft magnetic underlayer.

The second soft magnetic underlayer may have a thickness such that the energy density of a Neel wall is smaller than the energy density of a Bloch wall.

The thickness of the second soft magnetic underlayer may be in the range from 5 through 20 nm.

The perpendicular anisotropic middle layer may be formed of a semi-hard magnetic material.

The perpendicular anisotropic middle layer may be formed of a material selected from the group consisting of Co, CoFe alloy, and NiFe alloy.

The thickness of the perpendicular anisotropic middle layer may be in the range from 2 through 10 nm.

The perpendicular anisotropic middle layer may have a saturation magnetization of at least 5 kG.

The magnetic anisotropic energy of the perpendicular anisotropic middle layer may be in the range from 5×10⁵ erg/cc through 1×10⁶ erg/cc.

### BRIEF DESCRIPTION OF THE DRAWINGS

The above and other aspects of the present invention will become more apparent by describing in detail exemplary embodiments thereof with reference to the attached drawings in which:

FIG. 1 is a cross-sectional view of a perpendicular magnetic recording medium according to an exemplary embodiment of the present invention;

FIG. 2 is a graph illustrating the relationship between the thickness of a magnetic domain wall and the energy density of the magnetic domain wall;

FIGS. 3A and 3B illustrate the magnetization of a perpendicular magnetic recording medium during recording and after recording in a comparative example; and

FIGS. 4A and 4B illustrate the magnetization of a perpendicular magnetic recording medium during recording and after recording according to an exemplary embodiment of the present invention.

### DETAILED DESCRIPTION OF THE EXEMPLARY EMBODIMENTS OF THE INVENTION

The present invention will now be described more fully with reference to the accompanying drawings, in which exemplary embodiments of the invention are shown.

FIG. 1 is a cross-sectional view of a perpendicular magnetic recording medium according to an exemplary embodiment of the present invention.

Referring to FIG. 1, the perpendicular magnetic recording medium includes a substrate 10, a first soft magnetic underlayer 11, a perpendicular anisotropic middle layer 12, a second soft magnetic underlayer 13, and a perpendicular magnetic recording layer 15. Also, a protection layer 18 may be further formed on the perpendicular magnetic recording layer 15 to protect the perpendicular magnetic recording layer 15 from the outside. A lubricating layer 19 may be further formed on the protection layer 18 to reduce the abrasion of the magnetic head and the protection layer 18 due to collision and sliding of the magnetic head.

The first and second soft magnetic underlayers 11 and 13 allow the magnetic flux emitted from the magnetic head (not shown) to form a magnetic circuit in the magnetic recording medium during recording so that the perpendicular magnetic recording layer 15 is effectively magnetized. For this, the first and second soft magnetic underlayers 11 and 13 are formed of a soft magnetic material having a high permeability and low coercivity.

The first soft magnetic underlayer 11 may have a sufficient thickness having a relatively higher saturation magnetization than the saturation magnetization of the recording pole of the magnetic head. If the first soft magnetic underlayer 11 has a relatively small saturation magnetization and a thickness, the first soft magnetic underlayer 11 becomes saturated and the magnetic flux emitted from the magnetic head cannot properly pass therethrough.

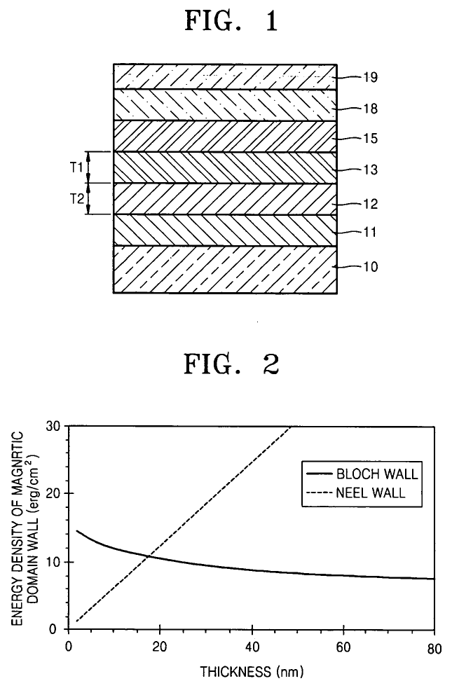

The second soft magnetic underlayer 13 may have a small thickness such that no magnetic vortex occurs. The thickness of the second soft magnetic underlayer 13 will be described with reference to FIG. 2. FIG. 2 is a graph illustrating the relationship of the thickness of a magnetic domain wall and the energy density of a magnetic domain wall when the second soft magnetic underlayer 13 has a saturation magnetization (Ms) of 17 kG.

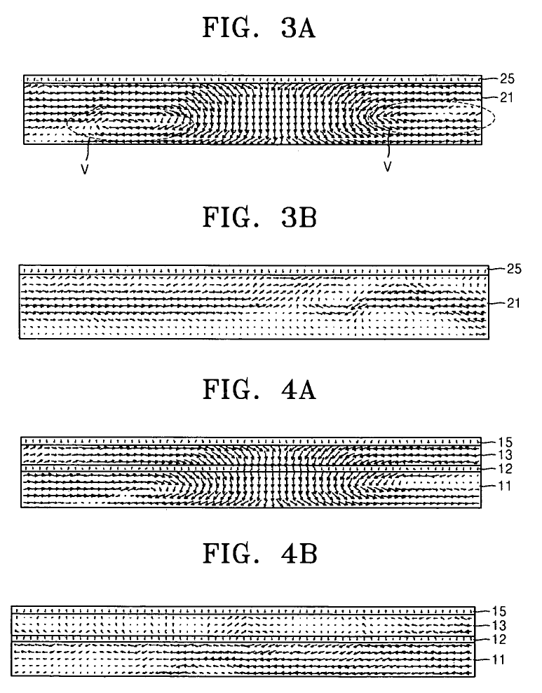

The magnetic domain wall can be of two forms: a Bloch wall and a Neel wall. The Bloch wall is a magnetic domain wall where switched magnetization is formed perpendicularly with respect to the second soft magnetic underlayer 13, and the Neel wall is a magnetic domain wall where switched magnetization is formed horizontally with respect to the second soft magnetic underlayer 13. The magnetic domain wall forms a boundary of the magnetic domain in the second soft magnetic underlayer 13 during magnetic recording or after magnetic recording. The magnetic vortex which is likely to occur during magnetic recording is formed in a perpendicular surface with respect to the second soft magnetic underlayer 13 (see V in FIG. 3), and thus is related to the Bloch wall. On the other hand, the magnetic vortex formed perpendicularly to the second soft magnetic underlayer 13 is not related to the Neel wall. Accordingly, Bloch walls where the magnetization is switched perpendicularly should not be formed in the second soft magnetic underlayer 13 in order to suppress the occurrence of a magnetic vortex.

As the energy density of the magnetic domain is related to the thickness of the second soft magnetic underlayer (13 in FIG. 1), the formation of the Bloch wall and the Neel wall is restricted by the thickness of the second soft magnetic underlayer 13. Accordingly, the second soft magnetic underlayer 13 should have a thickness which reduces the energy density of the Neel wall so as to be lower than the energy density of the Bloch wall. In other words, when the second soft magnetic underlayer 13 has a transition thickness, the energy density of the Neel wall is smaller than the energy density of the Bloch wall, and thus a Neel wall is formed at the boundary of the magnetic domain. Here, the transition thickness refers to the thickness of the second soft magnetic underlayer 13 at a transition position where the energy density of the Bloch wall and the energy density of the Neel wall are identical.

Referring to FIGS. 1 and 2, when Ms of the second soft magnetic underlayer 13 is 17 kG, the transition thickness of the second soft magnetic underlayer 13 is approximately 20 nm. In this case, if the thickness T1 of the second soft magnetic underlayer 13 is smaller than approximately 20 nm, the energy density of the Neel wall is smaller than the energy density of the Bloch wall, thereby facilitating the formation of the Neel wall easier than the Bloch wall, and semi-electronization perpendicular to the second soft magnetic underlayer 13 and magnetic vortex are suppressed. Meanwhile, the thickness T1 of the second soft magnetic underlayer 13 may be larger than 5 nm in order to have a stably thin layer. Accordingly, the thickness T1 of the second soft magnetic underlayer 13 may be in the range from 5 nm to 20 nm in order to suppress the magnetic vortex.

Referring to FIG. 1 again, the perpendicular anisotropic middle layer 12 may be formed of a semi-hard magnetic material having perpendicular magnetic anisotropy. The semi-hard magnetic material has a greater coercivity than the soft magnetic material and is magnetized more easily than the hard magnetic material. The characteristic of the semi-hard magnetic material is between the characteristics of the soft magnetic material and the hard magnetic material. The perpendicular anisotropic middle layer 12 formed of the semi-hard magnetic material is magnetized more easily than the perpendicular magnetic recording layer 15 formed of a hard magnetic material and has small coercivity. Therefore, the perpendicular anisotropic middle layer 12 allows together with the first and second soft magnetic underlayers 11 and 13 the magnetic flux emitted from the magnetic head to form a magnetic circuit easily in the magnetic recording medium so that the perpendicular magnetic recording medium 15 can be effectively magnetized. Also, the perpendicular anisotropic middle layer 12 has a greater coercivity and is more difficult to magnetize than the soft magnetic underlayers 11 and 13, and therefore can suppress the magnetic vortex which is likely to occur in the soft magnetic underlayers 11 and 13. For example, the perpendicular anisotropic middle layer 12 has Ms of approximately 5 kG, and the magnetic anisotropic energy Ku of the perpendicular anisotropic middle layer 12 is in the range from 5×10⁵ through 1×10⁶ erg/cc.

The perpendicular anisotropic middle layer 12 needs to have a layer thickness allowing perpendicular magnetic anisotropy. For example, the perpendicular anisotropic middle layer 12 may have a thickness T2 smaller than 10 nm. Meanwhile, the perpendicular anisotropic middle layer 12 can be formed using a thin layer process, and in this case, the thickness T2 of the perpendicular anisotropic middle layer 12 may be greater than 2 nm. Accordingly, the perpendicular anisotropic middle layer 12 may be greater than approximately 2 nm and smaller than approximately 10 nm. In order to have a stable thin layer, the perpendicular anisotropic middle layer 12 may be greater than 5 nm.

As the perpendicular anisotropic middle layer 12 has perpendicular anisotropy, a magnetic moment is arranged in the same direction as the recording magnetic field passing the perpendicular magnetic recording layer 15 perpendicularly. That is, since the magnetic moment of the perpendicular anisotropic middle layer 12 has the same direction as the magnetic moment arranged in the perpendicular magnetic recording layer 15, the perpendicular anisotropic middle layer 12 can intensify the recording magnetic field of the perpendicular magnetic recording layer 15. That is, during reproducing of the perpendicular magnetic recording medium, the perpendicular anisotropic middle layer 12 increases the output of the perpendicular magnetic recording medium, thereby improving the signal to noise reduction (SNR) characteristic.

The perpendicular anisotropic middle layer 12 may be formed of Co, CoFe alloy, or NiFe alloy. The anisotropic middle layer 12 can be formed by evaporation in a sputtering thin layer manufacturing method. For example, if the perpendicular anisotropic middle layer 12 is made of a Co thin layer, the Co thin layer is evaporated as a single layer so that the perpendicular anisotropic middle layer 12 can have the crystallic magnetic anisotropy in a perpendicular direction. Also, if the perpendicular anisotropic middle layer 12 is formed of CoFe alloy thin layer, a soft magnetic seed layer is first evaporated, and then a CoFe alloy thin layer is evaporated to have an elastic magnetic anisotropy.

The perpendicular magnetic recording layer 15 is a layer on which information is recorded magnetically in units of bits recorded when writing of the magnetic head is set up perpendicularly. For example, the perpendicular magnetic recording layer 15 may be formed of Co type alloy having excellent perpendicular magnetic anisotropy or Fe type alloy having strong magnetism.

FIGS. 3A through 4B illustrate a magnetic recording medium suppressing a magnetic vortex respectively in a comparative example and in an exemplary embodiment of the present invention.

### COMPARATIVE EXAMPLE

The magnetic recording medium illustrated in FIGS. 3A and 3B according to the prior art includes a single-layer soft magnetic underlayer 21 and a perpendicular magnetic recording layer 25 stacked thereon. FIG. 3A illustrates the magnetization during recording, and FIG. 3B illustrated the magnetization after recording. Here, the soft magnetic underlayer 21 has Ms of 15 kG, and the thickness thereof is 90 nm.

Referring to FIG. 3A, a magnetic vortex V occurs in the soft magnetic underlayer 21. The magnetic vortex V obstructs the fast switching of the magnetization of the soft magnetic underlayer 21 and thus delays the magnetization time such that information cannot be recorded on the magnetic recording medium with high density. Referring to FIG. 3B, the magnetic vortex (V in FIG. 3A) creates elements having a magnetic moment in the opposite direction to the direction of the magnetic moment arranged in the perpendicular magnetic recording layer 25 after recording on the soft magnetic underlayer 21, thereby causing noise.

### Exemplary Embodiment

FIGS. 4A and 4B illustrate a magnetic recoding medium which is substantially identical to the magnetic recording medium according to the related art except that the soft magnetic underlayer is divided into first and second soft magnetic underlayers 11 and 13 by the perpendicular anisotropic middle layer 12. The perpendicular anisotropic middle layer 12 is made of a semi-hard magnetic material having a perpendicular magnetic anisotropic energy of 1×10⁶ erg/cc and coercivity of 2000 Oe.

FIG. 4A illustrates the magnetization during recording according to an exemplary embodiment of the present invention, and FIG. 4B illustrates the magnetization after recording according to an exemplary embodiment of the present invention.

Referring to FIG. 4A, as the perpendicular anisotropic middle layer 12 is interposed between the first and second soft magnetic underlayers 11 and 13, the magnetic vortex in the first and second soft magnetic underlayers 11 and 13 is suppressed. Accordingly, the magnetization of the first and second soft magnetic underlayers 11 and 13 can be changed fast, thereby reducing the magnetization time of the magnetic recording medium. When the magnetization time is reduced, more information can be recorded in one unit of time, and it is advantageous to magnetically record information on the magnetic recording medium with high density.

Also, as the direction of the magnetic moment of the perpendicular anisotropic middle layer 12 is the same with the direction of the magnetic moment of the perpendicular magnetic recording layer 15, the recording magnetic field in the perpendicular magnetic recording layer 15 is intensified and the output during reproduction is increased, thereby securing a very good SNR characteristic.

As described above, the perpendicular magnetic recording medium having a perpendicular anisotropic middle layer interposed between the soft magnetic underlayers according to an exemplary embodiment of the present invention has the following advantages.

First, the magnetic vortex in the soft magnetic underlayer is suppressed, thereby reducing the magnetization time of the magnetic recording medium. This is advantageous for high density magnetic recording.

Second, noise created in the soft magnetic underlayers can be suppressed.

Third, the recording magnetic field of the perpendicular magnetic recording layer is intensified and the output is increased to secure excellent SNR characteristic.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A perpendicular magnetic recording medium comprising:
a substrate;
a first soft magnetic underlayer which is formed on the substrate;
a perpendicular anisotropic middle layer which is formed on the first soft magnetic underlayer and has perpendicular magnetic anisotropy;
a second soft magnetic underlayer which is formed on the perpendicular anisotropic middle layer; and
a perpendicular magnetic recording layer which is formed on the second soft magnetic underlayer.

2. The perpendicular magnetic recording medium of claim 1, wherein the second soft magnetic underlayer has a thickness such that the energy density of a Neel wall is smaller than the energy density of a Bloch wall.

3. The perpendicular magnetic recording medium of claim 2, wherein the thickness of the second soft magnetic underlayer is in the range from 5 through 20 nm.

4. The perpendicular magnetic recording medium of claim 1, wherein the perpendicular anisotropic middle layer is formed of a semi-hard magnetic material.

5. The perpendicular magnetic recording medium of claim 4, wherein the perpendicular anisotropic middle layer is formed of a material selected from the group consisting of Co, CoFe alloy, and NiFe alloy.

6. The perpendicular magnetic recording medium of claim 1, wherein the thickness of the perpendicular anisotropic middle layer is in the range from 2 through 10 nm.

7. The perpendicular magnetic recording medium of claim 1, wherein the perpendicular anisotropic middle layer has a saturation magnetization of at least 5 kG.

8. The perpendicular magnetic recording medium of claim 1, wherein the magnetic anisotropic energy of the perpendicular anisotropic middle layer is in the range from 5×10⁵ erg/cc through 1×10⁶ erg/cc.

9. The perpendicular magnetic recording medium of claim 1, further comprising:
a protection layer which is formed on the perpendicular magnetic recording layer; and
a lubricating layer which is formed on the protection layer.
